(19) United States
(12) Patent Application Publication
(10) Pub. No.: US 2004/0091301 A1
(43) Pub. Date: May 13, 2004

(54) Michine with X-axis double speed machanism

(76) Inventor: Chang-Hsin Kuo, Taichung City (TW)

Correspondence Address: CHARLES E. BAXLEY, ESQUIRE, Hart, Baxley, Daniels & Holton, 59 John St, 5Fl, New York, NY, 10038, US

(21) Appl. No.: 10/272,814

(22) Filed: Oct. 18, 2002

(51) Int. Cl. B41J 29/00

(52) U.S. Cl. 400/679

(57) ABSTRACT

A machine with X-axis double speed mechanism includes two axles along which the work piece carrying assembly and the tool fixing assembly are respectively moved in parallel with each other. The work piece carrying assembly and the tool fixing assembly are moved relatively so as to double the relative speed and to shorten the length of the machine.

### FIELD OF THE INVENTION

The present invention relates to a machine having double speed mechanism along the X direction.

### BACKGROUND OF THE INVENTION

A conventional machine which requires fast movement speed for the work piece or the tool such as rapid proto-typing machines, surface or cylinder grinders employ high speed motor, belt type gearing system, high-lead lead screw, or linear motor. Nevertheless, there are several problems that these improvements that are used cannot successfully solved. The longer distance of travel of the tool or the work piece to be machined makes the whole length of machine longer than the old ones. The longer length of the machine requires the longer and larger space to install therein. And, the lead screw is more likely to have deformation because the length and this affects the accuracy of machining. This induce the accuracy of machines is not excellent. Beside, although the linear motor without loading can up to a high acceleration of 4G (acceleration of gravity), the heavy base for carrying the tool or the work piece to be machined is so heavy, such that the acceleration for linear motor is only 1G under loading. When the object (work piece or tool) movement just reaches highest speed, it must to slow down for stopping before the end of the bench.

The present invention intends to provide a machine with X-axis and the speed in the X direction is double of that of the conventional machines.

### SUMMARY OF THE INVENTION

In accordance with one aspect of the present invention, there is provided a machine with X-axis double speed mechanism, which comprising a base, a work piece carrying assembly and a tool carrying assembly. The work piece carrying assembly is mounted on a top of the base. A carrying board is mounted to the work piece carrying assembly and movable along a direction, we call it the X direction, and which is the first axle. The tool fixing assembly, having a tool connected thereto, is mounted on the top of the base. And, the tool connecting to the tool fixing assembly is movable along a direction, which is the second axle. And, the first axle is parallel to the second axle.

The primary object of the present invention is to provide a machine with X-axis double speed mechanism that has shorter distance of travel and double speed for approaching the tool to the work piece to be machined.

Another object of the present invention is to provide a machine with X-axis double speed mechanism which can be approved the stability and stiffness of the present invention.

Yet another object of the present invention is to provide a machine with X-axis double speed mechanism which may be occupied less space and this is benefit for allocation the machines in a work site.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a front view to show the machine of the present invention.

FIG. 2 is a side view to show the machine of the present invention, and

FIG. 3 is a top view to show the machine of the present invention.

### DETAILED DESCRIPTION OF THE PREFERRED EMBODIMENT

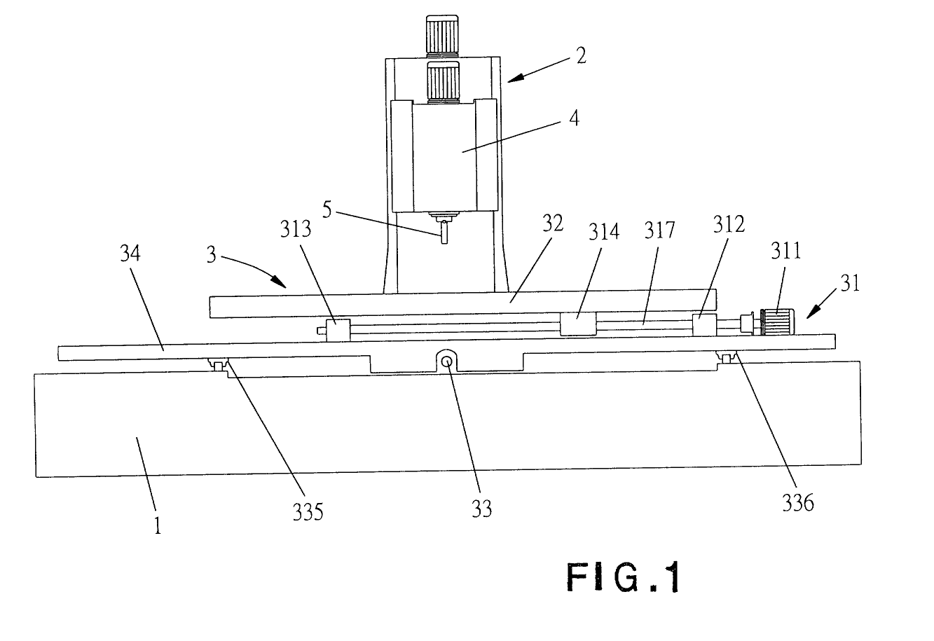

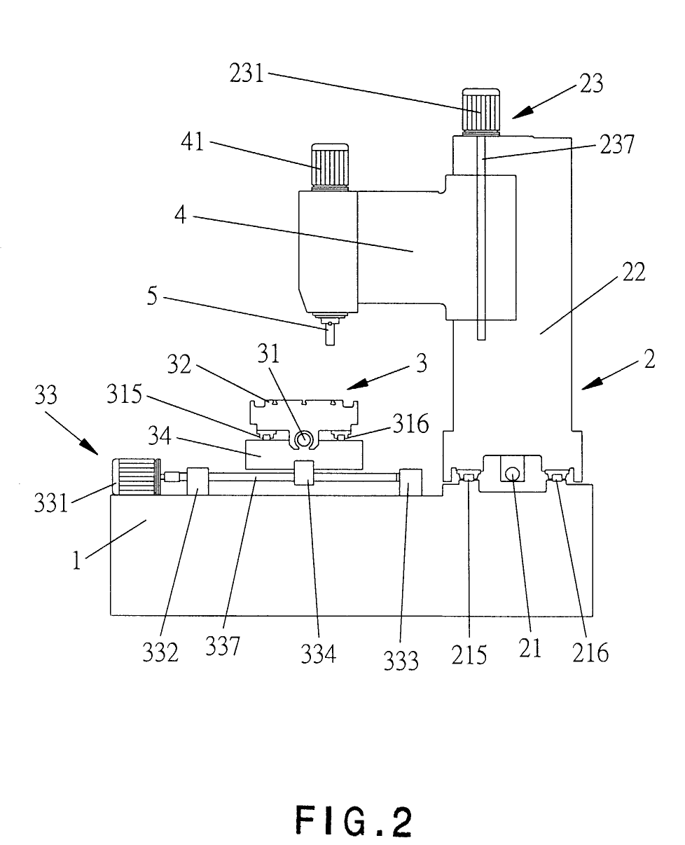

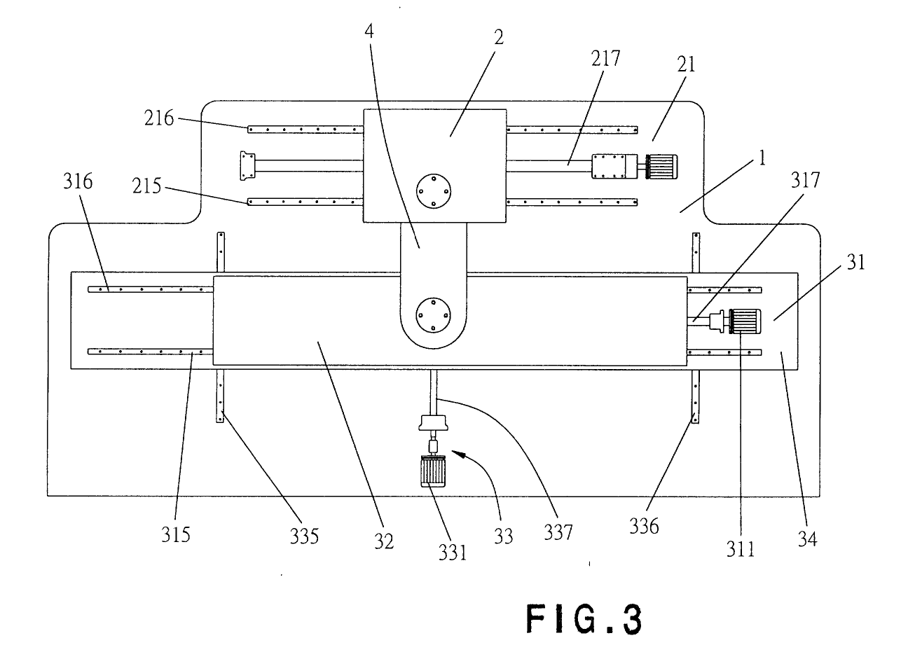

Referring to FIGS. 1 to 3, the machine of the present invention comprises a base 1, a tool fixing assembly 2 and a work piece carrying assembly 3. The work piece carrying assembly 3 is mounted on a top of the base 1. The work piece carrying assembly 3 includes a first axle 31, a carrying board 32, a third axle 33 and a saddle unit 34 at this embodiment. The first axle 31 further comprises a motor 311, two bearing sets 312 and 313, a nut 314, two rails 315 and 316, and a screw 317. The motor 311 connects to the screw 317, and drives the screw 317 rotating. Two bearing sets 312 and 313 support the screw 317. The nut 314 which connected to the carrying board 32 is movably mounted to the screw 317, and can carry the carrying board 32 moving along the direction of the screw 317. It transfers the rotational power of the motor 311 into the movement along the screw 317. Two rails 315 and 316 are respectively formed on the saddle unit 34 and may be used to limit the carrying board 32 moving direction relative to the saddle unit 34. The carrying board 32 is mounted on the first axle 31 and its moving direction is same to the direction of the screw 317, and we define it as the X direction.

A saddle unit 34 is located below the work piece carrying assembly 3 and movable along a third axle 33. The third axle 33 further comprises a motor 331, two bearing sets 332 and 333, a nut 334, two rails 335 and 336, and a screw 337. The motor 331 connects to the screw 337, and drives the screw 337 rotating. Two bearing sets 332 and 333 support the screw 337. The nut 334 which connected to the saddle unit 34 is movably mounted to the screw 337, and can carry the saddle unit 34 moving along the direction of the screw 337. Two rails 335 and 336 are respectively formed on the base 1 and may be used to limit the saddle unit 34 moving direction relative to the base 1. The saddle unit 34 is mounted on the third axle 33 and its moving direction is same to the direction of the screw 337. The third axle 33 is perpendicular to the first axle 31, and we define it as the Y direction.

The tool fixing assembly 2 is mounted on a top of the base 1, too. The tool fixing assembly 2 includes a second axle 21, an upright post 22 and a fourth axle 23. Similar to the first axle 31, the second axle 21 further comprises a motor (not shown), bearing sets (not shown), two rails 215 and 216, a screw 217, and the nut (not shown) for the screw 217. Two rails 215, 216 are respectively formed on the top of the base 1 and parallel to first axle 31. The screw 217 driven by a motor connects to the nut, and the nut drives the upright post 22 moving along the direction of the rails 215 and 216 which parallel to the first axle 31, the X direction.

The fourth axle 23 is located in the upright post 22 and perpendicular to the base 1. So, the fourth axle 23 is perpendicular to first axle 31(the X direction) and third axle 33(the Y direction), and we call the motion direction of the fourth axle 23 as Z direction. The fourth axle 23 further comprises a motor (231), bearing sets (not shown), rails (not shown), a screw 237, and a nut (not shown). The nut of the fourth axle 23 is connected to a tool chuck device 4, and can drive the tool chuck device 4 moving along the Z direction. The tool 5 is connected to the tool chuck device 4 and driven by a motor 41.

When the work piece settled on the work piece carrying assembly 3 moves to one direction along the first axle 31, the tool 5 settled on the fixing assembly 2 may move toward another direction along the second axle 21. The first axle 31 is parallel to the second axle 21. Such that, the relative speed for the work piece to be machined and the tool 5 is as double as the speed of the first axle 31 and second axle 21. So, the relative speed for the work piece and the tool 5 is as double as the speed that a conventional machine may have. In other words, if the right end of a long work piece wants to be machined, the carrying board 32 will move to left at a first speed and the tool 5 moves to right at a second speed. So, the tool 5 can reach the right end of the work piece at the sum of the first speed and the second speed. If the first speed is the same as the second speed, the sum will be double as either the first speed or the second speed.

The carrying board 32 and the tool 5 can move relative to the base 1, such that the total travel for the work piece relative to the tool 5 is the sum travel of the first axle 31 and the second axle 21. So, either the travel of the first axle 31 and the travel of the second axle 21 will shorter than the total travel of the machine in the embodiment of present invention. The total settled length of a machine must longer than the sum of the work piece length and total travel for prior art, but we can reduce a half of total travel in present invention. In present invention, the travel of the first axle 31 and the second axle 21 can be only a half of the total travel, and the length of the transfer parts (screws, rails . . . ) will be a half of the prior art. The total length of the machine is reduced in comparison with the conventional ones, so that it occupies less space and this is benefit for allocation of the machines in a work site. Beside, the length of each part of the machine is shortened so that the stiffness of the machine can be increased.

While we have shown and described the embodiment in accordance with the present invention, it should be clear to those skilled in the art that further embodiments may be made without departing from the scope of the present invention.

What is claimed is:

1. A machine with X-axis double speed mechanism, comprising:
a base;
a work piece carrying assembly having a first axle mounted on a top of said base, a carrying board mounted on said first axle and movable along the first axle, and
a tool fixing assembly having a second axle mounted on a top of said base,
wherein a tool connected to said tool fixing assembly may move along said second axle, and said first axle being parallel to said second axle.

2. The mechanism as claimed in claim 1, wherein said carrying board moves along one direction of said first axle and the tool moves toward the opposite direction relative to the direction that said carrying board moves.

3. The mechanism as claimed in claim 2, wherein both of the speed of the movements of the carrying board and the tool are the same.

4. The mechanism as claimed in claim 1 wherein the first axle and the second axle are screws.

5. The mechanism as claimed in claim 1, wherein the work piece carrying assembly comprises a horizontal third axle which is perpendicular to the first axle.

6. The mechanism as claimed in claim 1, wherein the tool fixing assembly includes a fourth axle which is perpendicular to the base and the tool connected to and movable along the fourth axle.
